(19) United States
(12) Patent Application Publication
(10) Pub. No.: US 2024/0008679 A1
(43) Pub. Date: Jan. 11, 2024

(54) Pizza Heating Apparatus

(71) Applicant: Jody Cibak, Pahrump, NV (US)

(72) Inventor: Jody Cibak, Pahrump, NV (US)

(21) Appl. No.: 17/859,967

(22) Filed: Jul. 7, 2022

(51) Int. Cl. A47J 36/24; H05B 1/02; A47J 36/32

(52) U.S. Cl. CPC A47J 36/2483; H05B 1/0258; A47J 36/32

(57) ABSTRACT

The present disclosure provides a heating pad which can support a pizza inside the pizza delivery box and keep it at an ideal temperature for consumption. The heating apparatus comprises a disc-like housing with a conductive top surface and a heating element such as an induction heating coil contained within, and with non-conductive supporting legs to prevent the box itself from burning. Various additional safety features and convenience features may be incorporated into the apparatus.

### FIELD OF INVENTION

The present invention relates generally to the technical field of food accessories. More specifically, the present invention relates to an apparatus for keeping a pizza heated in its delivery box.

### BACKGROUND

Pizza is one of the most popular, if not the most popular, delivery food type on the planet. Many households order pizza deliveries multiple times a week.

One of the benefits of pizza as a delivery food is that it can easily be kept stored in its pizza box until the user wishes to consume it, however doing so for extended periods of time causes the pizza to lose its heat, even through the best insulated pizza boxes. Users can reheat their pizzas before consumption using microwaves, for example, however this causes the pizza crust to lose its appealing fresh-baked texture, becoming dry and gummy.

It would be beneficial if households were equipped with an apparatus for keeping their pizzas at the desired temperature for extended periods so that it can be consumed at a more convenient time, while maintaining the ideal texture of the crust. It is within this context that the present invention is provided.

### SUMMARY

The present disclosure provides a heating pad which can support a pizza inside the pizza delivery box and keep it at an ideal temperature for consumption. The heating apparatus comprises a disc-like housing with a conductive top surface and a heating element such as an induction heating coil contained within, and with non-conductive supporting legs to prevent the box itself from burning. Various additional safety features and convenience features may be incorporated into the apparatus.

Thus, according to one aspect of the present disclosure there is provided a pizza heating apparatus, comprising: a housing, the housing forming a hollow disc structure having a first flat circular surface formed of a heat conducting material and being configured to support a pizza; a plurality of supporting legs formed of a non-heat conducting material, the supporting legs being coupled to an opposing second side of the housing; a power source; a heating element coupled to the power source, the heating element being disposed within the housing adjacent to the first surface.

In some embodiments, the apparatus further comprises a controller coupled to the power source and configured to couple or de-couple the power source from the heating element.

In such cases, the apparatus may also further comprise a thermostat in contact with the heating element, and the controller may be configured to measure the temperature of the heating element via the thermostat, and to de-couple the heating element from the power source in response to a detection that the heating element is at a temperature above a pre-determined threshold. The predetermined temperature threshold may be, for example, 160 degrees Fahrenheit.

The controller may also be configured to measure an amount of time that the heating element has been active and to de-couple the heating element from the power source in response to the elapsed time exceeding a predetermined threshold time. The predetermined threshold time may be, for example, 4 hours.

In some embodiments, the power source is a rechargeable battery.

In other embodiments, the power source is an outlet for connecting to a mains power supply. In such embodiments, the apparatus may further comprise a ground fault circuit interrupter plug for switching off the connection to the mains power supply in the event that a power surge or short circuit event occurs.

In some embodiments, the circular surface of the housing has a diameter chosen to accommodate a specific pizza size, with a diameter of 12″, 14″, or 16″.

### BRIEF DESCRIPTION OF THE DRAWINGS

Various embodiments of the invention are disclosed in the following detailed description and accompanying drawings.

FIG. 1 illustrates an isometric perspective view of an example configuration of the pizza heating apparatus of the present disclosure.

FIG. 2 illustrates an top-down view of the example configuration of the pizza heating apparatus.

FIG. 3 illustrates an bottom view of the example configuration of the pizza heating apparatus.

FIG. 4 illustrates a first side view of the example configuration of the pizza heating apparatus.

FIG. 5 illustrates a second side view of the example configuration of the pizza heating apparatus rotated by 90 degrees with respect to FIG. 4.

FIG. 6 illustrates a third side view of the example configuration of the pizza heating apparatus, flipped with respect to FIG. 5.

FIG. 7 illustrates an exploded isometric view of the housing and interior heating element and circuitry of the example configuration of the pizza heating apparatus.

FIG. 8 illustrates an isometric perspective view of the example configuration of the heating apparatus connected to a mains power outlet incorporating a safety shut-off feature.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

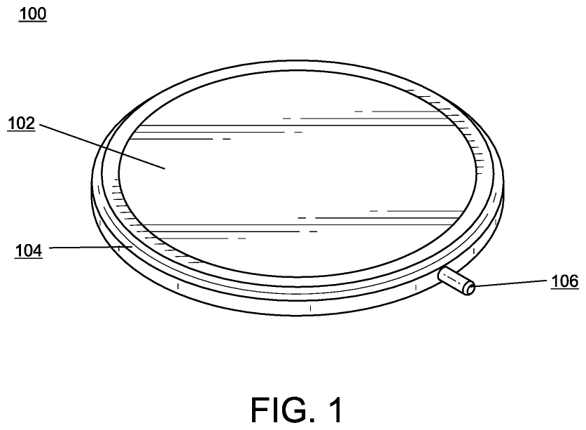

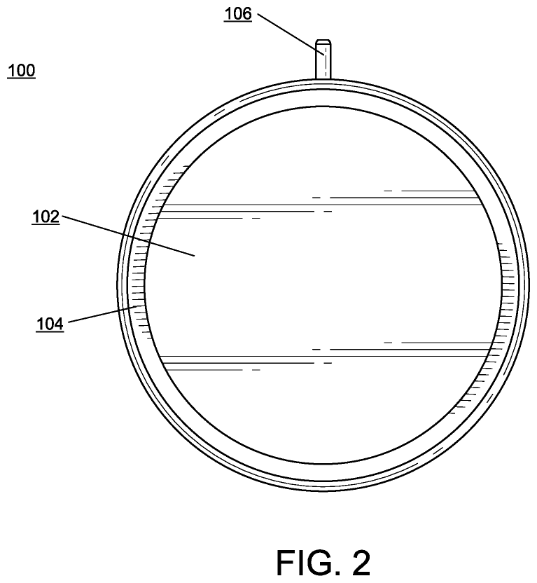

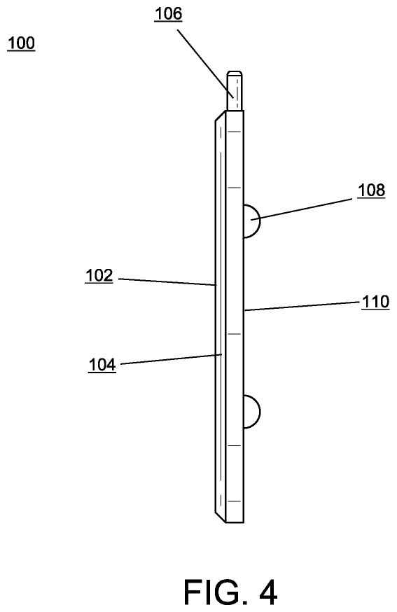

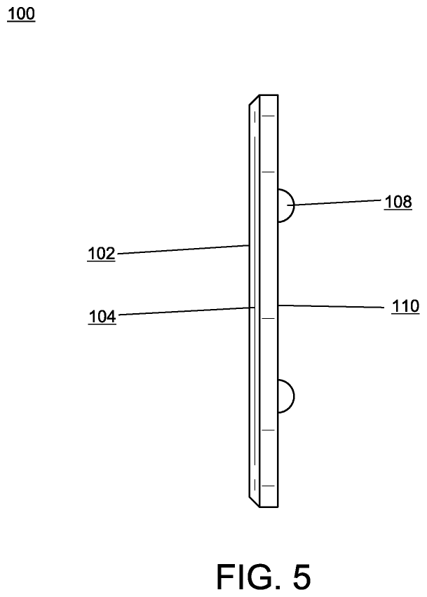

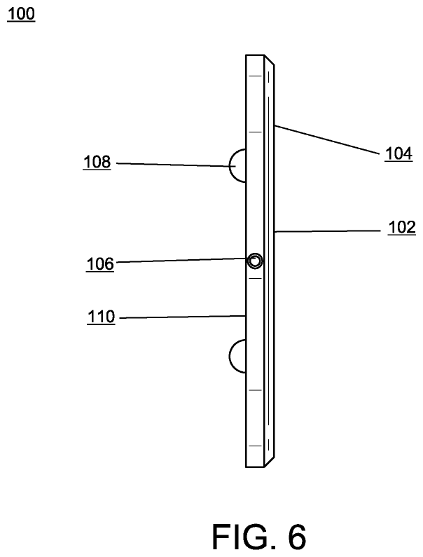

Referring to FIG. 1 through FIG. 6, various views of an example configuration of a pizza heating apparatus 100 according to the present disclosure are shown. This is one specific implementation of the heating apparatus, and the design should be construed as illustrative rather than limiting.

As can be seen, the apparatus 100 comprises a housing, the top of which is formed into a circular flat surface 102 which is configured to support a pizza and is formed of a conductive material in order to heat the pizza. This top surface 102, in the present example, is surrounded by a non-conductive outer ring 104, allowing the user to handle the apparatus 1090 even during use without burning their fingers.

In the present example, the power source of the apparatus will come from an external source, and thus a power outlet 106 for connecting the power source to the internal circuitry of the apparatus is provided on the side of the housing.

As can be seen from FIG. 1 and FIGS. 4-6, the housing is in a thin disc like structure, with the thickness being small enough that a pizza may be rested on and heated by the apparatus 100 inside the pizza delivery box it came in.

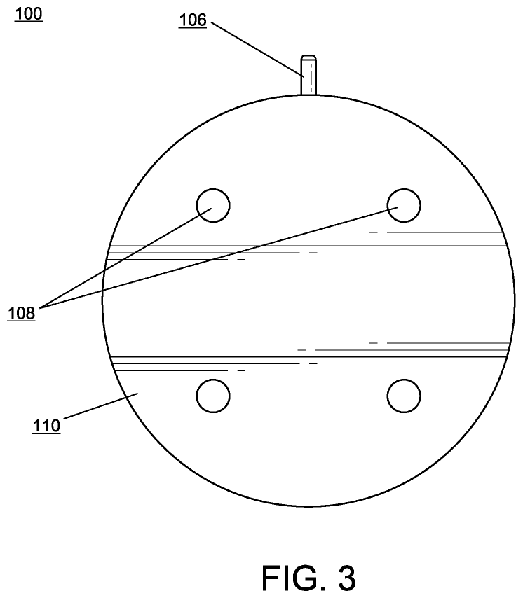

Referring to FIGS. 3-6, the opposing side 110 of the housing is shown as flat, but with a plurality of supporting legs 108 disposed on it. These supporting legs 108 would also be made of a non-heat conducting material, and allow the apparatus 100 to reach high temperatures within a cardboard enclosure without the risk of fire.

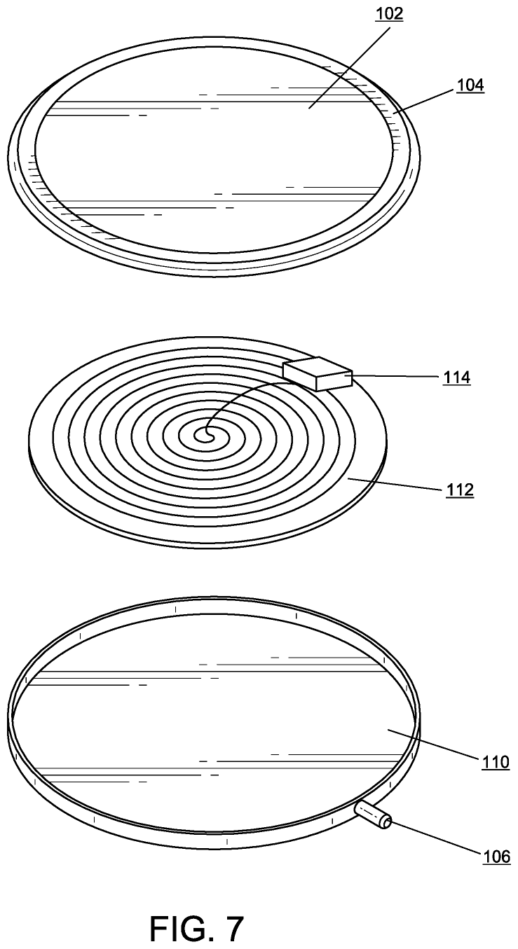

FIG. 7 illustrates an exploded view of the example configuration of the apparatus 100, with the internal heating element 112, which in the present example is an induction heating coil, and the connected circuitry 114 shown.

The circuitry 114 may be mounted for example on a PCB board and protected by its own housing, and may comprise a number of features for added safety and convenience. Many of these features may be implemented by a controller such as a microcontroller or chip and a switch or shut-off mechanism for controlling and de-coup0liing the power source 106 form the heating element 112.

For example, the circuitry 114 may comprise an “auto-off” feature, with an integrated timer that measures the amount of time the heating element 112 has been active and decouples the power after a predetermined time, such as after 4 hours of continuous operation. This prevents fire safety risks and overuse of energy when a user forgets the device is on.

The circuitry 114 may also comprise a thermostat in contact with the heating element 112 and configured to detect if the temperature is raised above a certain threshold level, decoupling the heating element 112 from the power source when the threshold level is reached. The threshold level may be 160 degrees Fahrenheit, for example.

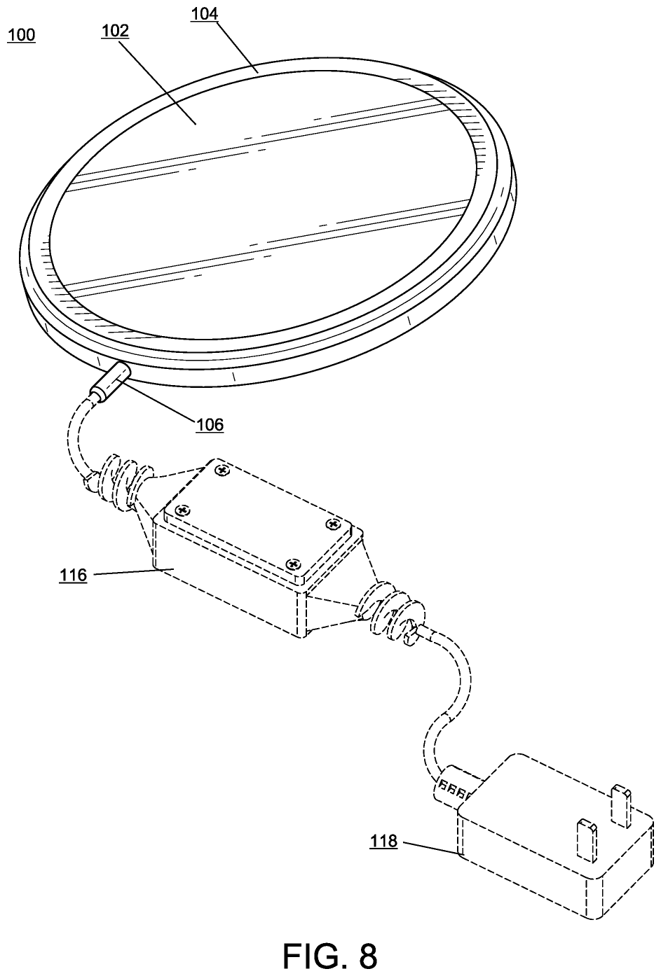

Finally, turning to FIG. 8, the apparatus 100 is shown with the power outlet connected to a mains power supply plug 118 that incorporates its own safety mechanism, a ground fault circuit interrupter 116 that shuts off power to the heating element 112 in the event of a power surge or short circuit caused by exposure to water and the like.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the heating apparatus have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A pizza heating apparatus, comprising:
a housing, the housing forming a hollow disc structure having a first flat circular surface formed of a heat conducting material and being configured to support a pizza;
a plurality of supporting legs formed of a non-heat conducting material, the supporting legs being coupled to an opposing second side of the housing;
a power source;
a heating element coupled to the power source, the heating element being disposed within the housing adjacent to the first surface.

2. A pizza heating apparatus according to claim 1, wherein the apparatus further comprises a controller coupled to the power source and configured to couple or de-couple the power source from the heating element.

3. A pizza heating apparatus according to claim 2, wherein the apparatus further comprises a thermostat in contact with the heating element, and wherein the controller is configured to measure the temperature of the heating element via the thermostat, and to de-couple the heating element from the power source in response to a detection that the heating element is at a temperature above a pre-determined threshold.

4. A pizza heating apparatus according to claim 3, wherein the predetermined temperature threshold is 160 degrees Fahrenheit.

5. A pizza heating apparatus according to claim 2, wherein the controller is configured to measure an amount of time that the heating element has been active and to de-couple the heating element from the power source in response to the elapsed time exceeding a predetermined threshold time.

6. A pizza heating apparatus according to claim 5, wherein the predetermined threshold time is 4 hours.

7. A pizza heating apparatus according to claim 1, wherein the power source is a rechargeable battery.

8. A pizza heating apparatus according to claim 1, wherein the power source is an outlet for connecting to a mains power supply.

9. A pizza heating apparatus according to claim 8, wherein the apparatus further comprises a ground fault circuit interrupter plug for switching off the connection to the mains power supply in the event that a power surge or short circuit event occurs.

10. A pizza heating apparatus according to claim 1, wherein circular surface of the housing has a diameter chosen to accommodate a specific pizza size, with a diameter of 12″, 14″, or 16″.
